(19) United States
(12) Patent Application Publication
(10) Pub. No.: US 2017/0288440 A1
(43) Pub. Date: Oct. 5, 2017

(54) SECONDARY CONTROL DEVICE AND CHARGING SYSTEM HAVING THE SAME

(71) Applicant: BYD COMPANY LIMITED, Shenzhen (CN)

(72) Inventors: Wenhui YE, Shenzhen (CN); Yongjun HOU, Shenzhen (CN); Haiquan ZHANG, Shenzhen (CN)

(21) Appl. No.: 15/513,577

(22) PCT Filed: Sep. 25, 2015
(86) PCT No.: PCT/CN2015/090805

§ 371 Date: Mar. 23, 2017

(30) Foreign Application Priority Data
Sep. 28, 2014 (CN) 201410510322.0

(51) Int. Cl. H02J 7/02; H02J 7/04; H02M 3/335

(52) U.S. Cl. CPC H02J 7/022; H02M 3/33592; H02J 7/045

(57) ABSTRACT

A secondary control device and a charging system are provided. The secondary control device is connected with a transformer having a secondary winding connected with a charging interface, and includes: a secondary rectifier switch connected with the secondary winding; a secondary synchronous rectifier chip connected with the secondary winding and the secondary rectifier switch, and configured to detect a voltage between two terminals of the secondary rectifier switch, to control the secondary rectifier switch to turn on or turn off according to the voltage, to control the secondary rectifier switch to turn on again when the secondary rectifier switch is in an off-state so as to control the secondary winding to generate a mutation voltage, to obtain a transmission signal on the charging interface, and to control a driving voltage of the secondary rectifier switch according to the transmission signal so as to adjust the mutation voltage.

### CROSS REFERENCE TO RELATED APPLICATION

This application claims priority and benefits of Chinese Patent Application No. 201410510322.0, filed with State Intellectual Property Office, P. R. C. on Sep. 28, 2014, the entire content of which is incorporated herein by reference.

### FIELD

Embodiments of the present disclosure generally relate to charging control field, and more particularly, to a secondary control device and a charging system having the secondary control device.

### BACKGROUND

With developments in science, various electronic products are used in daily life, and have become necessities in life, and thus how to charge these electronic products has become important. However, different electronic products have different charging specifications. For example, some electronic products require a voltage of 5V, some electronic products require a voltage 9V, and some electronic products require a voltage of 12V.

A solution to the above problem is to obtain a transmission signal from a terminal device via a D line of a USB interface, and to turn on corresponding MOS transistors selectively via a decoder chip, such that different ratios of divider resistor are put in circuit, and different voltages are outputted.

However, the above solution at least has following disadvantages.

1. A number of MOS transistors are needed for varying the output voltage, and additional components such as an opto-coupler and a controllable device are also needed for achieving the solution, thus increasing the cost.

2. Only the output voltage can be changed, but the output current cannot be changed accordingly, which will cause a phenomenon that a low power load is charged with a large current, affecting the life of the battery in the load.

### SUMMARY

Embodiments of the present disclosure seek to solve at least one of the problems existing in the related art to at least some extent.

Embodiments of a first aspect of the present disclosure provide a secondary control device, the secondary control device is connected with a transformer, the transformer has a secondary winding connected with a charging interface, and the secondary control device includes: a secondary rectifier switch connected with the secondary winding; and a secondary synchronous rectifier chip connected with the secondary winding and the secondary rectifier switch respectively, and configured to detect a voltage between two terminals of the secondary rectifier switch, to control the secondary rectifier switch to turn on or turn off according to the voltage between two terminals of the secondary rectifier switch, to control the secondary rectifier switch to turn on again when the secondary rectifier switch is in an off-state so as to control the secondary winding to generate a mutation voltage, to obtain a transmission signal on the charging interface, and to control a driving voltage of the secondary rectifier switch according to the transmission signal so as to adjust the mutation voltage.

With the secondary control device according to embodiments of the present disclosure, the secondary synchronous rectifier chip detects a voltage between two terminals of the secondary rectifier switch, controls the secondary rectifier switch to turn on or turn off according to the voltage between two terminals of the secondary rectifier switch, controls the secondary rectifier switch to turn on again when the secondary rectifier switch is in an off-state so as to control the secondary winding to generate the mutation voltage, obtains the transmission signal on the charging interface, and controls a driving voltage of the secondary rectifier switch according to the transmission signal so as to adjust the mutation voltage. In this way, the feedback winding may receive the mutation voltage feedback from the secondary winding and generate the output voltage switching signal according to the mutation voltage, and the primary control chip may sample the output voltage switching signal via the voltage feedback terminal to generate the selection signal and output the control signal to the primary switch according to the selection signal, so as to adjust the output voltage and the output current of the charging system, thus remaining a constant output power, and enabling to change the charging specification intelligently according to the load.

Embodiments of a second aspect of the present disclosure provide a charging system, and the charging system includes: a charging interface, configured to be connected with a load terminal; a transformer, having a primary winding, a secondary winding and a feedback winding, in which the secondary winding is connected with the charging interface; a rectifier module, configured to convert an input alternating current into a direct current and to charge the primary winding according to the direct current; a secondary control device, in which the feedback winding is configured to receive the mutation voltage feedback from the secondary winding, and to generate an output voltage switching signal according to the mutation voltage; and a primary control device comprising a primary control chip, a detecting resistor and a primary switch connected to grounded via the detecting resistor, in which the primary control chip has a voltage feedback terminal sampling a feedback voltage of the feedback winding and the output voltage switching signal and a voltage detecting terminal sampling a voltage of the detecting resistor, and is configured to generate a selection signal according to the output voltage switching signal, and to control the primary switch according to the selection signal, the voltage of the detecting resistor, and the feedback voltage of the feedback winding, so as to adjust an output voltage and an output current of the charging system.

With the charging system according to embodiments of the present disclosure, the secondary synchronous rectifier chip detects a voltage between two terminals of the secondary rectifier switch, controls the secondary rectifier switch to turn on or turn off according to the voltage between two terminals of the secondary rectifier switch, controls the secondary rectifier switch to turn on again when the secondary rectifier switch is in an off-state so as to control the secondary winding to generate the mutation voltage, obtains the transmission signal on the charging interface, and controls a driving voltage of the secondary rectifier switch according to the transmission signal so as to adjust the mutation voltage. The feedback winding receives the mutation voltage feedback from the secondary winding, and generates the output voltage switching signal according to the mutation voltage. The primary control chip samples the output voltage switching signal via the voltage feedback terminal to form the selection signal and outputs the control signal to the primary switch according to the selection signal, the voltage of the detecting resistor, and the feedback voltage of the feedback winding so as to adjust the output voltage and the output current of the charging system. Thus, the output power of the charging system can be constant, and the output charging specification can be changed intelligently according to the load. The charging system according to the present disclosure detects the transmission signal on the charging interface, such as the transmission signal on D line of the USB interface connected with the load terminal, and feedbacks the transmission signal to the primary control chip for adjusting the output voltage and the output current of the charging system, thus ensuring the output power constant. Thus, the battery life of the load terminal is not affected, and the cost is greatly reduced since no additional switches are added. In addition, the charging system according to the present disclosure performs the synchronous rectification control using the secondary rectifier switch and the secondary synchronous rectifier chip, and thus has a much smaller loss than the traditional solution using the freewheel diode, especially in a case that an output current of the charger has become larger and larger, a system conversion efficiency can be improved significantly using the secondary rectifier switch in combination with the secondary synchronous rectifier chip, which can meet a higher energy efficiency standard. Moreover, no opto-coupler and controllable device are used, thus greatly reducing the secondary static loss and making it easy to realize an ultra-low standby power consumption.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic diagram showing a charging system according to an embodiment of the present disclosure;

FIG. 2 is a schematic diagram showing an operation principle of a secondary synchronous rectification according to an embodiment of the present disclosure;

FIG. 3 is schematic diagram illustrating operation waveforms of a secondary synchronous rectifier chip according to an embodiment of the present disclosure;

FIG. 4 is a schematic diagram of a secondary synchronous rectifier chip according to an embodiment of the present disclosure;

FIG. 5 is a schematic diagram of a first driving module according to an embodiment of the present disclosure;

FIG. 6 is a schematic diagram illustrating an output voltage of a charging system according to an embodiment of the present disclosure;

FIG. 7 is a schematic diagram illustrating operation waveforms of a primary control chip according to an embodiment of the present disclosure;

FIG. 8 is a schematic diagram illustrating operation waveforms of a primary control chip according to an embodiment of the present disclosure; and

FIG. 9 is a schematic diagram of a sampling module according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied. Moreover, a structure in which a first feature is “on” a second feature may include an embodiment in which the first feature directly contacts the second feature, and may also include an embodiment in which an additional feature is formed between the first feature and the second feature so that the first feature does not directly contact the second feature.

In the description of the present disclosure, unless specified or limited otherwise, it should be noted that, terms “mounted,” “connected” and “coupled” may be understood broadly, such as electronic connections or mechanical connections, inner communications between two elements, direct connections or indirect connections through intervening structures, which can be understood by those skilled in the art according to specific situations.

With reference to the following descriptions and drawings, these and other aspects of embodiments of the present disclosure will become apparent. In the descriptions and drawings, some particular embodiments are described in order to show the principles of embodiments according to the present disclosure. However, it should be appreciated that the scope of embodiments according to the present disclosure is not limited herein. To the contrary, changes, alternatives, and modifications can be made in the embodiments without departing from spirit, principles and scope of the attached claims.

In the following, a charging system, and a secondary control device are described in detail with reference to drawings.

FIG. 1 is a schematic diagram of a charging system according to an embodiment of the present disclosure. As shown in FIG. 1, the charging system includes a transformer 10, a rectifier module 20, a secondary control device 30, a primary control device 40 and a charging interface 50. The charging interface 50 is connected with a load terminal and configured to output a voltage and current for charging the load terminal.

In an embodiment, the transformer 10 has a primary winding 11, a secondary winding 12 connected with a charging interface 50, and a feedback winding 13. The rectifier module 20 (such as a rectifier bridge consisting of four diodes) is configured to convert an input alternating current AC into a direct current V_{DC} and to charge the primary winding 11 according to the direct current V_{DC}. The secondary control device 30 includes a secondary rectifier switch 31 and a secondary synchronous rectifier chip 32. The secondary rectifier switch 31 is connected with the secondary winding 12. The secondary synchronous rectifier chip 32 is connected with the secondary winding 12 and the secondary rectifier switch 31 respectively, and is configured to detect a voltage between two terminals of the secondary rectifier switch 31, to control the secondary rectifier switch 31 to turn on or turn off according to the voltage between two terminals of the secondary rectifier switch 31, to control the secondary rectifier switch 31 to turn on again when the secondary rectifier switch 31 is in an off-state so as to control the secondary winding 12 to generate a mutation voltage, to obtain a transmission signal on the charging interface 50 (such as a transmission signal on a D line of an USB interface connected with the load terminal), and to control a driving voltage of the secondary rectifier switch 31 according to the transmission signal, so as to adjust the mutation voltage. The feedback winding 13 is configured to receive the mutation voltage feedback from the secondary winding 12 and to generate an output voltage switching signal according to the mutation voltage. The primary control device 40 includes a primary control chip 41, a detecting resistor R0 and a primary switch 42 connected to ground via the detecting resistor R0. For example, when the primary switch 42 is a MOS transistor M40, a source electrode of the MOS transistor M40 is connected to ground via the detecting resistor R0. The primary control chip 41 has a voltage feedback terminal 2 sampling the feedback voltage of the feedback winding 13 and the output voltage switching signal, and a voltage detecting terminal 5 sampling the voltage of the detecting resistor R0. The primary control chip 41 is configured to generate a selection signal according to the output voltage switching signal, and to control the primary switch 42 according to the selection signal, the voltage of the detecting resistor R0, and the feedback voltage of the feedback winding 13, so as to adjust an output voltage and an output current of the charging system. Thus, an output power of the charging system can be constant, and an output charging specification can be changed intelligently according to the load.

In an embodiment, as shown in FIG. 1, the secondary rectifier switch 31 includes a first MOS transistor M1, the first MOS transistor M1 has a drain electrode connected with a first terminal of the feedback winding 13, a gate electrode and a source electrode. The secondary synchronous rectifier chip 32 includes a first power terminal VDD connected with a second terminal of the feedback winding 13, a voltage sampling terminal VD connected with the first terminal of the feedback winding 13 and a drain electrode of the first MOS transistor M1 respectively, a first driving control terminal DRV connected with the gate electrode of the first MOS transistor M1, a first ground terminal GND connected with the source electrode of the first MOS transistor M1, and a signal receiving terminal LS connected with the charging interface 50. In other words, the secondary synchronous rectifier chip 32 has five pins, the VDD pin is configured to detect the output voltage of the charging system and configured as the power terminal for the secondary synchronous rectifier chip 32, the DRV pin is configured to drive the first MOS transistor M1 and control the first MOS transistor M1 to turn on or turn off, the VD pin is configured to detect the drain voltage of the first MOS transistor M1, which decides whether to turn on or turn off the first MOS transistor M1, the GND pin is configured as the ground of the secondary synchronous rectifier chip 32, and the LS pin is configured to detect the transmission signal on the charging interface 50, such as the transmission signal on D line of the USB interface.

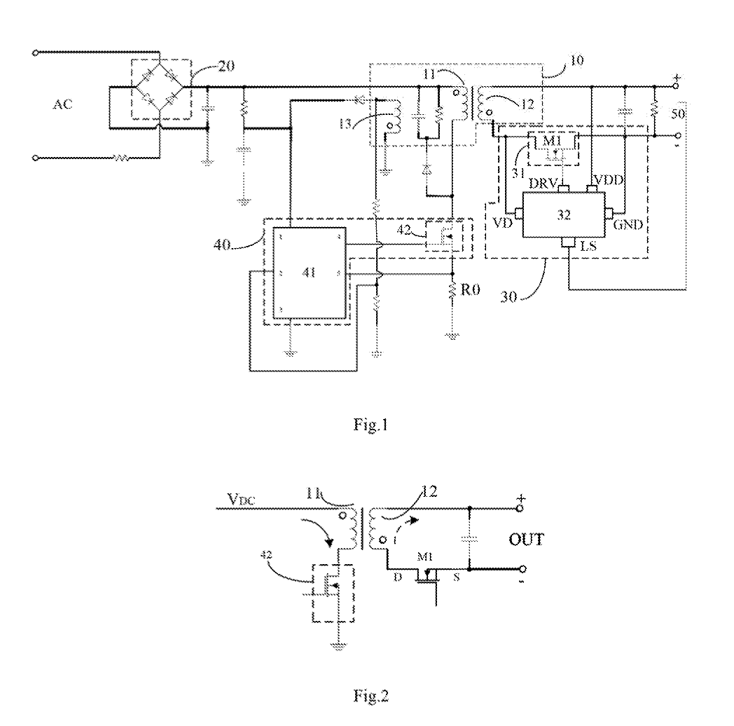

FIG. 2 is a schematic diagram illustrating an operation principle of a secondary synchronous rectification according to an embodiment of the present disclosure. As shown in FIG. 2, when the primary switch 42 is turned on, the primary winding 11 is charged, the first MOS transistor M1 is turned off, and the output current is equal to 0. When the primary switch 42 is turned off, the primary winding 11 discharges to the secondary winding 12 via a magnetic field, the first MOS transistor M1 is turned on, the secondary winding 12 is equivalent to a current, and the direction of the current is consistent with the primary current. The first MOS transistor M1 is not turned off until the secondary winding 12 completes discharging.

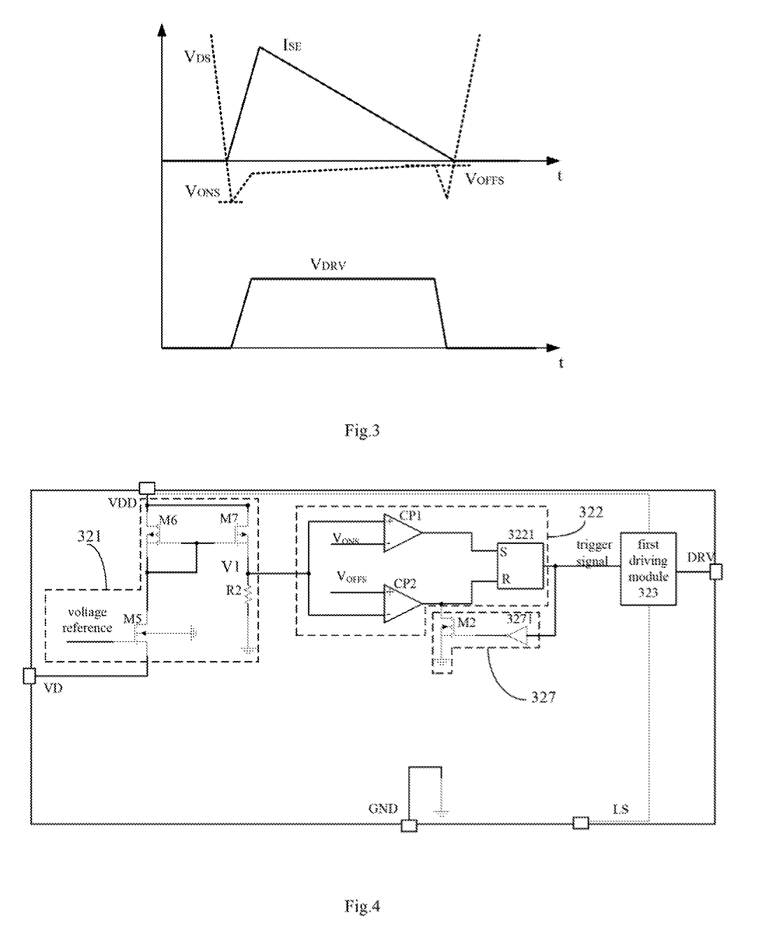

FIG. 3 is a schematic diagram illustrating operation waveforms of a secondary synchronous rectifier chip according to an embodiment of the present disclosure. As shown in FIG. 3, when the primary winding 11 is charged, the secondary current is equal to 0, and thus the voltage drop between two terminals of the secondary winding 12 is equal to 0, the drain voltage V_{D} of the first MOS transistor M1 is equal to the drain-source voltage V_{DS} of the first MOS transistor M1 and the output voltage V_{OUT} of the charging system, i.e. V_{D}=V_{OUT}=V_{DS}. When the primary winding 11 discharges (the discharging current is I_{SE}), the secondary current and the primary current have the same direction, the voltage drop between two terminals of the secondary winding 12 is greater than the output voltage V_{OUT} of the charging system, and thus the drain voltage V_{D} is negative. When the voltage detected by the VD pin of the secondary synchronous rectifier chip 32 is large enough, i.e., larger than a first reference voltage V_{ONS}, the DRV pin of the secondary synchronous rectifier chip 32 controls the first MOS transistor M1 to turn on, the secondary winding 12 charges the output capacitor. With the discharging of the primary winding 11, the drain voltage V_{D} of the first MOS transistor M1 increases gradually, and when the drain voltage V_{D} of the first MOS transistor M1 is larger than a second reference voltage V_{OFF}, the secondary synchronous rectifier chip 32 controls the first MOS transistor M1 to turn off, and the discharging process from the primary winding 11 to the secondary winding 12 is over, V_{D}=V_{OUT}=V_{DS}.

In addition, in one switching cycle of the secondary rectifier switch 31 such as the first MOS transistor M1, the secondary rectifier switch 31 only needs to be turned on once and turned off once. The secondary synchronous rectifier chip 32 detects the voltage between the drain electrode and the source electrode of the first MOS transistor M1 and controls the first MOS transistor M1 to turn on or off according to the voltage between the drain electrode and the source electrode of the first MOS transistor M1, thus achieving freewheeling. In an embodiment, the secondary rectifier switch 31 is controlled to turn on again when the secondary rectifier switch 31 is in the off-state, such that the mutation voltage may be generated over the secondary winding 12, and the mutation voltage is proportional to the drain voltage of the first MOS transistor M1

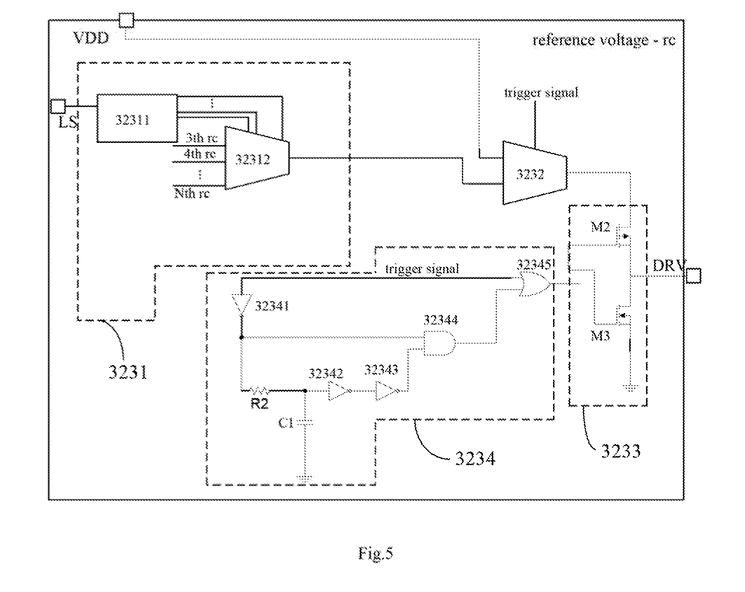

FIG. 4 is a schematic diagram of a secondary synchronous rectifier chip according to an embodiment of the present disclosure. As shown in FIG. 4, the secondary synchronous rectifier chip 32 includes a current mirror module 321, a first comparing and trigger module 322, and a first driving module 323.

The current mirror module 321 is connected with the first power terminal VDD and the voltage sampling terminal VD respectively, and is configured to generate a first voltage V1 according to the drain voltage of the first MOS transistor M1 when the drain voltage of the first MOS transistor M1 is less than a first predetermined voltage. Specifically, as shown in FIG. 4, the current mirror module 321 includes a fifth MOS transistor M5, a sixth MOS transistor M6, a seventh MOS transistor M9 and a first resistor R1. A source electrode of the fifth MOS transistor M5 is connected with the voltage sampling terminal VD, a gate electrode of the fifth MOS transistor M5 is connected with a voltage reference, a drain electrode of the fifth MOS transistor M5 is connected with a source electrode of the sixth MOS transistor M6, the gate electrode of the sixth MOS transistor M6, and the gate electrode of the seventh MOS transistor M7 respectively, the drain electrode of the sixth MOS transistor M6 and the drain electrode of the seventh MOS transistor M7 are connected with the first power terminal VDD, a source electrode of the seventh MOS transistor M7 is connected with a first terminal of the first resistor R1 and is configured as an output terminal of the first voltage V1. When the voltage sampling terminal VD detects a negative voltage, the fifth MOS transistor M5 is turned on to generate a branch current, the branch current generates the first voltage V1 on the first resistor R1 via the sixth MOS transistor M6 and the seventh MOS transistor M7. The first voltage V1 is proportional to the amplitude of the negative voltage detected at the voltage sampling terminal VD. In an embodiment, the first predetermined voltage is equal to 0.

The first comparing and trigger module 322 is connected with the current mirror module 321, and is configured to generate a first trigger signal when the first voltage V1 is larger than the first reference voltage V_{ONS} and to generate a second trigger signal when the first voltage is less than the second reference voltage V_{OFFS}. As shown in FIG. 4, the first comparing and trigger module 322 includes a first comparator CP1, a second comparator CP2, and a first RS trigger 3221. The first comparator CP1 has an in-phase input terminal connected with an output terminal of the current mirror module 321, an inverting input terminal connected with the first reference voltage V_{ONS} and an output terminal. The second comparator CP2 has an in-phase input terminal connected with the second reference voltage V_{OFFS}, an inverting input terminal connected with the output terminal of the current mirror module 321 and an output terminal. The first RS trigger 3221 has an S terminal connected with the output terminal of the first comparator CP1, an R terminal connected with the output terminal of the second comparator CP2 and an output terminal connected with the first driving module 323. Thus, when the first voltage V₁ is larger than the first reference voltage V_{ONS}, the first comparator CP1 outputs a high level signal, the first RS trigger 3221 is set to be high, i.e., outputs the first trigger signal, the first driving module 323 controls the first MOS transistor M1 to turn on according to the first trigger signal. When the first MOS transistor M1 is turned on, the amplitude of the negative voltage at the voltage sampling terminal VD drops gradually, and the first voltage V1 also drops. When the first voltage V is less than the second reference voltage V_{OFFS}, the second comparator CP2 outputs a high level signal, the first RS trigger 3221 is set to be low, i.e. outputs the second trigger signal, and the first driving module 323 controls the first MOS transistor M1 to turn off according to the second trigger signal.

In an embodiment, as shown in FIG. 4, the secondary synchronous rectifier chip 32 includes a shielding module 327 connected with the output terminal of the second comparator CP2. The shielding module 327 is configured to shield an output signal of the second comparator when the drain voltage of the first MOS transistor M1 is larger than the first predetermined voltage. As shown in FIG. 4, the shielding module 327 includes a fourth invertor 3271 and a fourth MOS transistor M4. The fourth invertor 3271 has an input terminal connected with the output terminal of the first RS trigger 3221 and an output terminal. The fourth MOS transistor M4 has a gate electrode connected with the output terminal of the fourth invertor 3271, a drain electrode connected with the output terminal of the second comparator CP2 and a source electrode connected to ground. In other words, the fourth invertor 3271 and the fourth MOS transistor M4 are configured to shield the output signal of the second comparator CP2 when the voltage at the voltage sampling terminal VD is larger than 0. That is, the output signal of the second comparator CP2 is valid only when the first comparator CP1 outputs the high level signal, and the second reference voltage is valid only when the first reference voltage is triggered.

FIG. 5 is a schematic diagram of a first driving module 323 according to an embodiment of the present disclosure. As shown in FIG. 4 and FIG. 5, The first driving module 323 is connected with the first comparing and trigger module 322, the first power terminal VDD and the signal receiving terminal LS respectively, and is configured to control the first MOS transistor M1 to turn on or turn off according to the transmission signal, a voltage at the first power terminal VDD, the first trigger signal and the second trigger signal.

As shown in FIG. 5, the first driving module 323 includes a gating circuit 3231, a first gating unit 3232, a pulse generating unit 3234, and a switch unit 3233. The gating circuit 3231 is connected with the signal receiving terminal LS, and is configured to select one from N reference voltages (the third reference voltage, the fourth reference voltage, . . . , the (N+2)th reference voltage) and to output a selected reference voltage, in which N is an integer greater than or equal to 2. The first gating unit 3232 has a first terminal connected with the first power terminal VDD, a second terminal connected with an output terminal of the gating circuit 3231, a control terminal connected with the output terminal of the first comparing and trigger module 322 and an output terminal, and is configured to output the voltage at the first power terminal VDD when receiving the first trigger signal and to output the selected reference voltage when receiving the second trigger signal. The pulse generating unit 3234 is connected with the output terminal of the first comparing and trigger module 322 and is configured to generate a pulse signal according to the first trigger signal and the second trigger signal. The switch unit 3233 is connected with the output terminal of the pulse generating unit 3234 and the output terminal of the first gating unit 3232 respectively, and is configured to control the first MOS transistor M1 to turn on according to the voltage at the first power terminal VDD, to control the first MOS transistor M1 to continue an on-state according to the selected reference voltage, in which a continuation time of the on-state of the first MOS transistor M1 is based on a duty ratio of the pulse signal. When the continuation time is over, the first MOS transistor M1 is turned off. In other words, since the pulse generating unit 3234 delays the second trigger signal, the first MOS transistor M1 is still turned on according to the first trigger signal when the second comparator CP2 outputs the second trigger signal. However, when the delay time is over, the first MOS transistor M1 is turned off according to the second trigger signal. In the delay time, the first MOS transistor M is still turned on, although the second comparator CP2 has already output the second trigger signal.

As shown in FIG. 5, the gating circuit 3231 includes a decoder 32311 and a second gating unit 32312. The decoder 32311 is connected with the signal receiving terminal LS, and is configured to output N selection signals via N channels according to the transmission signal. The second gating unit 32312 is connected with the N channels of the decoder 32311 and the N reference voltages, and is configured to select one from the N reference voltages according to the N selection signals and output the selected reference voltage.

As shown in FIG. 5, the pulse generating unit 3234 includes a first invertor 32341, a second resistor R2, a capacitor C1, a second invertor 32342, a third invertor 32343, a first AND gate 32344, and a first OR gate 32345. The first invertor 32341 has an input terminal connected with the output terminal of the first comparing and trigger module 322 and an output terminal. The second resistor R2 has a first terminal connected with the output terminal of the first invertor 32341 and a second terminal. The capacitor C1 has a first terminal connected with the second terminal of the second resistor R2 and a second terminal connected to ground. The second invertor 32342 has an input terminal connected with the second terminal of the second resistor R2 and an output terminal. The third invertor 32343 has an input terminal connected with the output terminal of the second invertor 32342 and an output terminal. The first AND gate 32344 has a first input terminal connected with the input terminal of the first invertor 32341, a second input terminal connected with the output terminal of the third invertor 32343 and an output terminal. The first OR gate 32345 has a first input terminal connected with the output terminal of the first comparing and trigger module 323, a second input terminal connected with the output terminal of the first AND gate 32344 and an output terminal connected with the switch unit 3233.

As shown in FIG. 5, the switch unit 3233 may include a second MOS transistor M2 and a third MOS transistor M3. The second MOS transistor M2 has a drain electrode connected with the output terminal of the first gating unit 32341, a source electrode connected with the first driving control terminal DRV and a gate electrode. The third MOS transistor M3 has a drain electrode connected with the first driving control terminal DRV, a source electrode connected to ground and a gate electrode connected with the gate electrode of the second MOS transistor M2.

In an embodiment, as shown in FIG. 5, the transmission signal such as the transmission signal on D line of the USB interface is sent to the decoder 32311 of the secondary synchronous rectifier chip via the signal receiving terminal LS, the decoder 32311 outputs one selection signal to the second gating unit 32312 according to the transmission signal, the second gating unit 32312 selects one from the N reference voltages according to the selection signal sent from the decoder 32311, in which the N reference voltages represent different output voltages respectively. The first gating unit 3232 outputs the voltage at the first power terminal VDD when receiving the first trigger signal (i.e. the trigger signal is the high level signal), and outputs the output voltage outputted from the second gating unit 32312 when receiving the second trigger signal (i.e. the trigger signal is the low level signal).

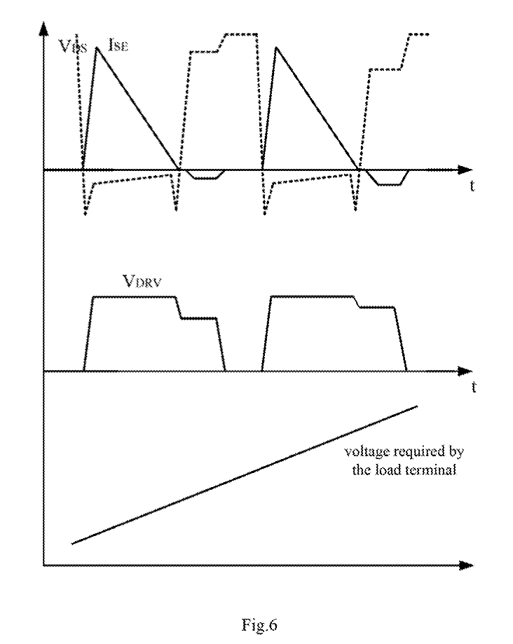

FIG. 6 is a schematic diagram illustrating an output voltage of a charging system according to an embodiment of the present disclosure. When receiving the first trigger signal (i.e. the trigger signal is the high level signal), the first gating unit 3232 outputs the voltage at the first power terminal VDD, the voltage at the first power terminal VDD is output to the first driving control terminal DRV, and then the first MOS transistor M1 is controlled to turn on. When receiving the second trigger signal (i.e. the trigger signal is the low level signal), the first gating unit 3232 selects one from the N reference voltages for output, the output voltage of the first gating unit 3232 is output to the first driving control terminal DRV via the second MOS transistor M2 and the third MOS transistor M3 of the switch unit 3233, and then the first MOS transistor M1 is controlled to turn off when the delay time is over, in which the delay time is determined by the pulse generating unit 3234. Specifically, the waveforms of the voltage at the first driving control terminal DRV and the voltage required by the load terminal are shown in FIG. 6. As shown in FIG. 6, the secondary synchronous rectifier chip 32 detects the transmission signal on the charging interface such as the transmission signal on the D line of the USB interface and outputs the corresponding signal to the primary control chip 41.

With the secondary control device according to embodiments of the present disclosure, the secondary synchronous rectifier chip detects the voltage between terminals of the secondary rectifier switch, controls the secondary rectifier switch to turn on or turn off according to the voltages, controls the secondary rectifier switch to turn on again when the secondary rectifier switch is in an off-state so as to control the secondary winding to generate the mutation voltage, obtains the transmission signal on the charging interface, and controls a driving voltage of the secondary rectifier switch according to the transmission signal so as to adjust the mutation voltage. In this way, the feedback winding may receive the mutation voltage feedback from the secondary winding and generate the output voltage switching signal according to the mutation voltage, and the primary control chip may sample the output voltage switching signal via the voltage feedback terminal to generate the selection signal and output the control signal to the primary switch according to the selection signal, so as to adjust the output voltage and the output current of the charging system, thus remaining a constant output power, and enabling to change the charging specification intelligently according to the load.

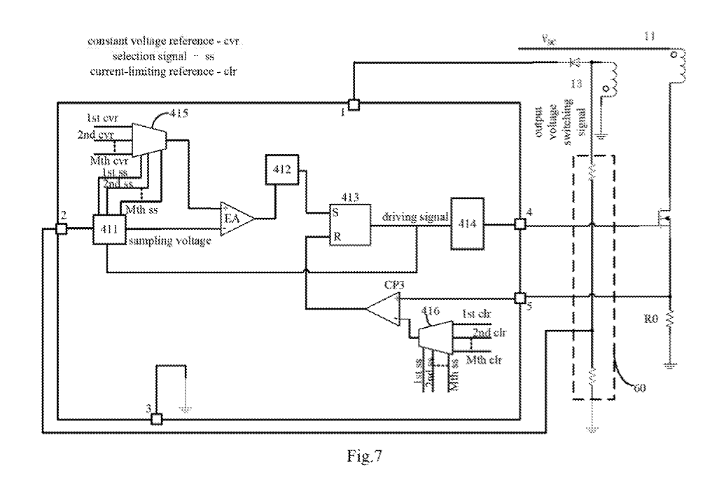

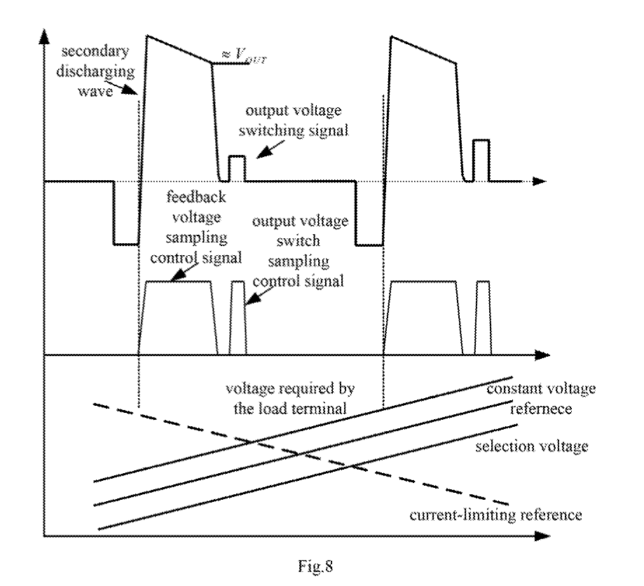

FIG. 7 is a schematic diagram illustrating operation waveforms of a primary control chip according to an embodiment of the present disclosure. As shown in FIG. 7, the primary control chip 41 includes a sampling module 411, a third gating unit 415, a fourth gating unit 416, an error amplifier EA, an internal oscillator 412, a third comparator CP3, a second RS trigger 413 and a second driving module 414.

In an embodiment, the sampling module 411 is connected with the voltage feedback terminal 2, and configured to output M selection signals via M selection output terminals according to the output voltage switching signal, to generate a sampling voltage according to the feedback voltage of the feedback winding 12 and to output the sampling voltage, in which M is an integer greater than or equal to 2. The third gating unit 415 is connected with M selection output terminals and M constant voltage references respectively, and is configured to select one from the M constant voltage references according to one of the M selection signals and to output a voltage adjusting signal according to a selected constant voltage reference. The fourth gating unit 416 is connected with M selection output terminals and M limiting-current references respectively, and is configured to select one from the M limiting-current references according one of the M selection signals and to output a current adjusting signal according to a selected limiting-current reference. The error amplifier EA has a first input terminal (+) connected with an output terminal of the third gating unit 415, a second input terminal (−) connected with an output terminal of the sampling module 411 and an output terminal, and is configured to output an error amplifying signal according to the sampling voltage and the voltage adjusting signal. The internal oscillator 412 has an input terminal connected with the output terminal of the error amplifier EA and an output terminal, and is configured to adjust an output frequency according to the error amplifying signal. The third comparator CP3 has an in-phase input terminal connected with the voltage detecting terminal 5, an inverting input terminal connected with the fourth gating unit 416 and an output terminal, and is configured to generate a first comparing signal according to the voltage of the detecting resistor and the current adjusting signal. The second RS trigger 413 has an S terminal connected with the output terminal of the internal oscillator 412, an R terminal connected with the output terminal of the third comparator CP3 and an output terminal, and is configured to output according to the output frequency and the first comparing signal a driving signal for controlling the primary switch 42. The second driving module 414 is connected with the output terminal of the second RS trigger 413, and is configured to control the primary switch 42 to turn on or turn off according to the driving signal.

In an embodiment, as shown in FIG. 7, a voltage signal feedback from the secondary control device 40 is sent to the voltage feedback terminal 2 via a resistor divider module 60, and then is sent to the sampling module 411 of the primary control chip 41 via the voltage feedback terminal 2.

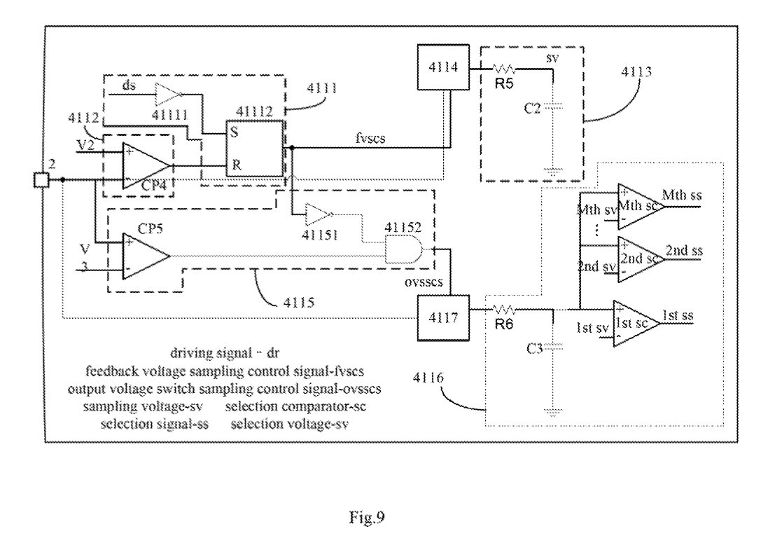

FIG. 8 is a schematic diagram illustrating operation waveforms of a primary control chip according to an embodiment of the present disclosure. The sampling module 411 samples peak voltage of the voltage signal feedback from the secondary control device 40 (i.e. the feedback voltage of the feedback winding 12), the peak voltage is sent to the error amplifier EA to be amplified, the output signal of the error amplifier EA is sent to the internal oscillator 412 for adjusting an output frequency of the internal oscillator 412, so as to change the operation frequency of the charging system. According to a power formula of a flyback application topology P=½·I_{P}²·L·f·η=I_{OUT}·V_{OUT}, when the output current of the charging system decreases, the output voltage of the charging system increases, and when the primary control 10o chip 41 detects the change of the output voltage, the change of the output voltage is adjusted by the error amplifier EA for controlling the internal oscillator 412 to decrease the operation frequency of the charging system, thus decreasing the overall power of the charging system, suppressing the output voltage of the charging control system rise, and achieving a constant output voltage. In addition, the output voltage switching signal feedback from the secondary control device 40 is sent to the sampling module 411, and the sampling module 411 generates the M selection signals (i.e. the first selection signal, the second selection signal . . . , and the Mth selection signal), which are sent to the third gating unit 415 and the fourth gating unit 416 synchronously. The third gating unit 415 selects the constant voltage reference corresponding to the transmission signal, i.e. the first constant voltage reference, the second constant voltage reference, . . . , and the Mth constant voltage reference, so as to adjust the output voltage. The fourth gating unit 416 selects the limiting-current reference corresponding to the transmission signal, i.e. the first limiting-current reference, the second limiting-current reference, . . . , the Mth limiting-current reference, so as to adjust the output current. The constant voltage reference selected by the third gating unit 415 has a negative relationship with the reference current selected by the fourth gating unit 416. That is, it can ensure that the charging system outputs the constant output power under different output voltages.

FIG. 9 is a schematic diagram of a sampling module according to an embodiment of the present disclosure. As shown in FIG. 9, the sampling module 411 includes a trigger unit 4111, a feedback voltage sampling control unit 4112, a sample voltage generating unit 4113, a first transmission gate 4114, an output voltage switch sampling control unit 4115, a selection signal generating unit 4116, and a second transmission gate 4117.

As shown in FIG. 9, the trigger unit 4111 is connected with the output terminal of the second RS trigger 413, and configured to output a feedback voltage sampling start signal when the driving signal is at a low level. The trigger unit 4111 includes a fifth invertor 41111 and a third RS trigger unit 41112. The feedback voltage sampling control unit 4112 is connected with the voltage feedback terminal 2 and the trigger unit 4111, and is configured to compare the feedback voltage with a second predetermined voltage when receiving the feedback voltage sampling start signal, and to output a feedback voltage sampling control signal according to a comparing result. In an embodiment, the second predetermined voltage is equal to 0. The feedback voltage sampling control unit 4112 includes a fourth comparator CP4 having an in-phase input terminal connected with 0V voltage, an inverting input terminal connected with the voltage feedback terminal 2, and an output terminal connected with a R terminal of the third RS trigger unit 41112, an S terminal of the third RS trigger unit 41112 is connected with an output terminal of the fifth invertor 41111.

As shown in FIG. 9, the first transmission gate 4114 is connected with the voltage feedback terminal 2, the sample voltage generating unit 4113, and the feedback voltage sampling control unit 4112 respectively, and is configured to output the feedback voltage to the sample voltage generating unit 4113 under a control of the feedback voltage sampling control signal, such that the sample voltage generating unit 4113 generates the sampling voltage according to the feedback voltage. The sample voltage generating unit 4113 includes a fifth resistor R5 and a second capacitor C2, a first terminal of the fifth resistor RS is connected with a first terminal of the second capacitor C2, a second terminal of the second capacitor C2 is connected to ground, a second terminal of the fifth resistor R5 is connected with an output terminal of the first transmission gate 4114.

As shown in FIG. 9, the output voltage switch sampling control unit 4115 is connected with the voltage feedback terminal 2 and the feedback voltage sampling control unit 4112 respectively, and is configured to compare a voltage corresponding to the output voltage switching signal with a third predetermined voltage, to output a second comparing signal according to the comparing result, and to generate an output voltage switch sampling control signal according to the feedback voltage sampling control signal and the second comparing signal. In an embodiment, the third predetermined voltage is equal to 0.1V. The second transmission gate 4117 is connected with the voltage feedback terminal 2, the selection signal generating unit 4116, and the output voltage switch sampling control unit 4115 respectively, and configured to output the output voltage switching signal to the selection signal generating unit 4116 under a control of the output voltage switch sampling control signal, such that the selection signal generating unit 4116 generates the M selection signals according to the output voltage switching signal. The output voltage switch sampling control unit 4115 includes a fifth comparator CP5, a sixth invertor 41151 and a second AND gate 41152, an in-phase input terminal of the fifth comparator CP5 is connected with the voltage feedback terminal 2, an inverting input terminal of the fifth comparator CP5 is connected with 0.1V voltage, an output terminal of the fifth comparator CP5 connected with a first input terminal of the second AND gate 41152, a second input terminal of the second AND gate 41152 is connected with an output terminal of the sixth invertor 41151, an output terminal of the second AND gate 41152 is connected with the second transmission gate 4117. The selection signal generating unit 4116 includes a sixth resistor R6, a third capacitor C3 and a first selection comparator, a second selection comparator, . . . , and an Mth selection comparator.

In an embodiment, as shown in FIG. 9, when the driving signal flips to the low level, the driving signal is sent to the third RS trigger 41112 via the fifth invertor 41111 for generating the feedback voltage sampling start signal. The fourth comparator CP4 compares a sampled feedback voltage with 0V, and the output signal of the fourth comparator CP4 is sent to the R terminal of the third RS trigger 41112 as the feedback voltage sampling end signal. The third RS trigger unit 41112 outputs the feedback voltage sampling control signal for controlling the first transmission gate 4114 to turn on. When the first transmission gate 4114 is turned on, a sampling voltage is formed after filtering the peak value of the feedback voltage signal via the fifth resistor R5 and the second capacitor C2. Meanwhile, the voltage corresponding to the output voltage switching signal is compared with 0.1V, the output signal of the fifth comparator CP5 is performed on an AND operation with an inversion signal of the output signal of third RS trigger 41112 to form the output voltage switch sampling control signal for controlling the second transmission gate 4117 to turn on. When the second transmission gate 4117 is turned on, the peak value of the output voltage switching signal is filtered via the sixth resistor R6 and the third capacitor C3, and then input into the first selection comparator, the second selection comparator, . . . , and the Mth selection comparator for generating M selection signals, i.e. the first selection signal, the second selection signal . . . , and the Mth selection signal, in which the inverting input terminals of the first selection comparator, the second selection comparator . . . , and the Mth selection comparator are connected with the first selection voltage, the second selection voltage . . . , and the Mth selection voltage respectively.

In embodiments of the present disclosure, the traditional freewheel diode is replaced with the first MOS transistor M1 and the secondary synchronous rectifier chip 32, the secondary synchronous rectifier chip 32 detects the voltage between the drain electrode and the source electrode of the first MOS transistor M1 and turns on the first MOS transistor M1 according to the drain-source voltage, thus achieving freewheeling. Furthermore, the secondary synchronous rectifier chip 32 controls the first MOS transistor M1 to turn on again when the first MOS transistor M1 is in an off-state, thus enabling the secondary winding to generate the mutation voltage. In addition, the secondary synchronous rectifier chip 32 detects the transmission signal on the charging interface 50 (such as the transmission signal on the D line of the USB interface connected with the load terminal). This is because, when the secondary synchronous rectifier chip 32 controls the first MOS transistor M1 to turn on again, the mutation voltage may be generated over the secondary winding 12 and the mutation voltage is proportional to the grid drive voltage of the first MOS transistor M1. When the secondary synchronous rectifier chip 32 obtains the transmission signal on the charging interface 50, it chooses different grid drive voltage of the first MOS transistor M1 so as to enable the mutation voltage to be relative with the transmission signal, and the mutation voltage is transferred to the feedback winding 13 from the secondary winding 12. After sampling the mutation voltage at the voltage feedback terminal 2, the primary control chip 41 generates the selection signal related with the transmission signal via the sampling module, such that the corresponding constant voltage reference (i.e. the output voltage of the charging system) and the limiting-current reference (the maximum charging current of the primary winding) are selected. That is, the corresponding output voltage and the corresponding output current are output, and thus it can ensure that the output power of the charging system is constant, and the charging specification can be changed intelligently according to the load.

With the charging system according to embodiments of the present disclosure, the secondary synchronous rectifier chip detects the voltage between two terminals of the secondary rectifier switch, controls the secondary rectifier switch to turn on or turn off according to the voltage between two terminal of the secondary rectifier switch, controls the secondary rectifier switch to turn on again when the secondary rectifier switch is in an off-state so as to control the secondary winding to generate the mutation voltage, obtains the transmission signal on the charging interface, and controls a driving voltage of the secondary rectifier switch according to the transmission signal so as to adjust the mutation voltage. The feedback winding receives the mutation voltage feedback from the secondary winding, and generates the output voltage switching signal according to the mutation voltage. The primary control chip samples the output voltage switching signal via the voltage feedback terminal to form the selection signal and outputs the control signal to the primary switch according to the selection signal, the voltage of the detecting resistor, and the feedback voltage of the feedback winding so as to adjust the output voltage and the output current of the charging system. Thus, the output power of the charging system can be constant, and the output charging specification can be changed intelligently according to the load. The charging system according to the present disclosure detects the transmission signal on the charging interface, such as the transmission signal on D line of the USB interface connected with the load terminal, and feedbacks the transmission signal to the primary control chip for adjusting the output voltage and the output current of the charging system, thus ensuring the output power constant. Thus, the battery life of the load terminal is not affected, and the cost is greatly reduced since no additional switches are added. In addition, the charging system according to the present disclosure performs the synchronous rectification control using the secondary rectifier switch and the secondary synchronous rectifier chip, and thus has a much smaller loss than the traditional solution using the freewheel diode, especially in a case that an output current of the charger has become larger and larger, a system conversion efficiency can be improved significantly using the secondary rectifier switch in combination with the secondary synchronous rectifier chip, which can meet a higher energy efficiency standard. Moreover, no opto-coupler and controllable device are used, thus greatly reducing the secondary static loss and making it easy to realize an ultra-low standby power consumption.

Any procedure or method described in the flow charts or described in any other way herein may be understood to comprise one or more modules, portions or parts for storing executable codes that realize particular logic functions or procedures. Moreover, advantageous embodiments of the present disclosure comprises other implementations in which the order of execution is different from that which is depicted or discussed, including executing functions in a substantially simultaneous manner or in an opposite order according to the related functions. This should be understood by those skilled in the art which embodiments of the present disclosure belong to.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment.

It is understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A secondary control device, connected with a transformer, wherein the transformer has a secondary winding connected with a charging interface, and the secondary control device comprises:
a secondary rectifier switch connected with the secondary winding; and
a secondary synchronous rectifier chip connected with the secondary winding and the secondary rectifier switch respectively, and configured:
to detect a voltage between two terminals of the secondary rectifier switch,
to control the secondary rectifier switch to turn on or turn off according to the voltage between two terminals of the secondary rectifier switch,
to control the secondary rectifier switch to turn on again when the secondary rectifier switch is in an off-state so as to control the secondary winding to generate a mutation voltage,
to obtain a transmission signal on the charging interface, and
to control a driving voltage of the secondary rectifier switch according to the transmission signal so as to adjust the mutation voltage.

2. The secondary control device of claim 1, wherein the secondary rectifier switch comprises a first MOS transistor having a drain electrode connected with a first terminal of the secondary winding, a gate electrode and a source electrode; and
the secondary synchronous rectifier chip has a first power terminal connected with a second terminal of the secondary winding, a voltage sampling terminal connected with the first terminal of the secondary winding and a drain electrode of the first MOS transistor respectively, a first driving control terminal connected with the gate electrode of the first MOS transistor, a first ground terminal connected with the source electrode of the first MOS transistor, and a signal receiving terminal connected with the charging interface.

3. The secondary control device of claim 2, wherein the secondary synchronous rectifier chip comprises:
a current mirror module, connected with the first power terminal and the voltage sampling terminal respectively, and configured to generate a first voltage according to a drain voltage of the first MOS transistor when the drain voltage of the first MOS transistor is less than a first predetermined voltage;
a first comparing and trigger module, connected with the current mirror module, and configured to generate a first trigger signal when the first voltage is greater than a first reference voltage and to generate a second trigger signal when the first voltage is less than a second reference voltage; and
a first driving module, connected with the first comparing and trigger module, the first power terminal and the signal receiving terminal respectively, and configured to control the first MOS transistor to turn on or turn off according to the transmission signal, a voltage at the first power terminal, the first trigger signal and the second trigger signal.

4. The secondary control device of claim 3, wherein the first driving module comprises:
a gating circuit, connected with the signal receiving terminal, and configured to select one from N reference voltages according to the transmission signal received at the signal receiving terminal and to output a selected reference voltage, in which N is an integer greater than or equal to 2;
a first gating unit having a first terminal connected with the first power terminal, a second terminal connected with an output terminal of the gating circuit, a control terminal connected with an output terminal of the first comparing and trigger module and an output terminal, and configured to output the voltage at the first power terminal when receiving the first trigger signal and to output the selected reference voltage when receiving the second trigger signal;
a pulse generating unit, connected with the output terminal of the first comparing and trigger module and configured to generate a pulse signal according to the first trigger signal and the second trigger signal; and
a switch unit, connected with an output terminal of the pulse generating unit and the output terminal of the first gating unit respectively, and configured to control the first MOS transistor to turn on according to the voltage at the first power terminal, to control the first MOS transistor to continue an on-state according to the selected reference voltage, in which a continuation time of the on-state of the first MOS transistor is based on a duty ratio of the pulse signal.

5. The secondary control device of claim 4, wherein the gating circuit comprises:
a decoder, connected with the signal receiving terminal, and configured to output N selection signals via N channels according to the transmission signal; and
a second gating unit, connected with the N channels of the decoder and N reference voltages, and configured to select one from the N reference voltages according to the N selection signals and to output the selected reference voltage.

6. The secondary control device of claim 4, wherein the pulse generating unit comprises:
a first invertor, having an input terminal connected with the output terminal of the first comparing and trigger module and an output terminal;
a resistor, having a first terminal connected with the output terminal of the first invertor and a second terminal;
a capacitor, having a first terminal connected with the second terminal of the first resistor and a second terminal connected to ground;
a second invertor, having an input terminal connected with the second terminal of the resistor and an output terminal;
a third invertor, having an input terminal connected with the output terminal of the second invertor and an output terminal;
a first AND gate, having a first input terminal connected with the output terminal of the first invertor, a second input terminal connected with the output terminal of the third invertor and an output terminal; and
a first OR gate, having a first input terminal connected with the output terminal of the first comparing and trigger module, a second input terminal connected with the output terminal of the first AND gate and an output terminal connected with the switch unit.

7. The secondary control device of claim 4, wherein the switch unit comprises:
a second MOS transistor having a drain electrode connected with the output terminal of the first gating unit, a source electrode connected with the first driving control terminal, and a gate electrode; and
a third MOS transistor having a drain electrode connected with the first driving control terminal, a source electrode connected to ground and a gate electrode connected with the gate electrode of the second MOS transistor.

8. The secondary control device of claim 1, wherein the first comparing and trigger module comprises:
a first comparator, having an in-phase input terminal connected with an output terminal of the current mirror module, an inverting input terminal connected with the first reference voltage, and an output terminal;
a second comparator, having an in-phase input terminal connected with the second reference voltage, an inverting input terminal connected with the output terminal of the current mirror module, and an output terminal;
a first RS trigger, having an S terminal connected with the output terminal of the first comparator, an R terminal connected with the output terminal of the second comparator and an output terminal connected with the first driving module.

9. The secondary control device of claim 8, wherein the secondary synchronous rectifier chip further comprises a shielding module connected with the output terminal of the second comparator, and configured to shield an output signal of the second comparator when the drain voltage of the first MOS transistor is greater than the first predetermined voltage.

10. The secondary control device of claim 9, wherein the shielding module comprises:
a fourth invertor, having an input terminal connected with the output terminal of the first RS trigger and an output terminal; and
a fourth MOS transistor, having a gate electrode connected with the output terminal of the fourth invertor, a drain electrode connected with the output terminal of the second comparator and a source electrode connected to ground.

11. A charging system, comprising:
a charging interface, configured to be connected with a load terminal;
a transformer, having a primary winding, a secondary winding and a feedback winding, wherein the secondary winding is connected with the charging interface and is controlled to generate a mutation voltage;
a rectifier module, configured to convert an input alternating current into a direct current and to charge the primary winding according to the direct current;
a secondary control device connected with the transformer, wherein the feedback winding is configured to receive the mutation voltage feedback from the secondary winding, and to generate an output voltage switching signal according to the mutation voltage; and
a primary control device comprising a primary control chip, a detecting resistor and a primary switch connected to ground via the detecting resistor, wherein the primary control chip has a voltage feedback terminal sampling the output voltage switching signal and a feedback voltage of the feedback winding and a voltage detecting terminal sampling a voltage of the detecting sensor, and is configured to generate a selection signal according to the output voltage switching signal, and to control the primary switch according to the selection signal, the voltage of the detecting resistor, and the feedback voltage of the feedback winding, so as to adjust an output voltage and an output current of the charging system.

12. The charging system according to claim 11, wherein the primary control chip comprises:
a sampling module, connected with the voltage feedback terminal, and configured to output M selection signals via M selection output terminals according to the output voltage switching signal, to generate a sampling voltage according to the feedback voltage of the feedback winding and to output the sampling voltage, in which M is an integer greater than or equal to 2;
a third gating unit, connected with M selection output terminals and M constant voltage references respectively, and configured to select one from the M constant voltage references according the M selection signals and to output a voltage adjusting signal according to a selected constant voltage reference;
a fourth gating unit, connected with M selection output terminals and M limiting-current references respectively, and configured to select one from the M limiting-current references according to the M selection signals and to output a current adjusting signal according to a selected limiting-current reference;
an error amplifier, having a first input terminal connected with an output terminal of the third gating unit, a second input terminal connected with an output terminal of the sampling module and an output terminal, and configured to output an error amplifying signal according to the sampling voltage and the voltage adjusting signal;
an internal oscillator, having an input terminal connected with the output terminal of the error amplifier and an output terminal, and configured to adjust an output frequency according to the error amplifying signal;
a third comparator, having an in-phase input terminal connected with the voltage detecting terminal, an inverting input terminal connected with the fourth gating unit and an output terminal, and configured to generate a first comparing signal according to the voltage of the detecting resistor and the current adjusting signal;
a second RS trigger, having an S terminal connected with the output terminal of the internal oscillator, a R terminal connected with the output terminal of the third comparator and an output terminal, and configured to output a driving signal for controlling the primary switch according to the output frequency and the first comparing signal;
a second driving module, connected with the output terminal of the second RS trigger, and configured to control the primary switch to turn on or turn off according to the driving signal.

13. The charging system according to claim 12, wherein the selected constant voltage reference has a negative relationship with the selected limiting-current reference.

14. The charging system according to claim 13, wherein the sampling module comprises:
a trigger unit, connected with the output terminal of the second RS trigger, and configured to output a feedback voltage sampling start signal when the driving signal is at a low level;
a feedback voltage sampling control unit, connected with the voltage feedback terminal and the trigger unit, and configured to compare the feedback voltage with a second predetermined voltage when receiving the feedback voltage sampling start signal, and to output a feedback voltage sampling control signal according to a comparing result;
a sample voltage generating unit;
a first transmission gate, connected with the voltage feedback terminal, the sample voltage generating unit, and the feedback voltage sampling control unit respectively, and configured to output the feedback voltage to the sample voltage generating unit under a control of the feedback voltage sampling control signal, such that the sample voltage generating unit generates the sampling voltage according to the feedback voltage;
an output voltage switch sampling control unit, connected with the voltage feedback terminal and the feedback voltage sampling control unit respectively, and configured to compare a voltage corresponding to the output voltage switching signal with a third predetermined voltage, to output a second comparing signal according to a comparing result, and to generate an output voltage switch sampling control signal according to the feedback voltage sampling control signal and the second comparing signal;
a selection signal generating unit; and
a second transmission gate, connected with the voltage feedback terminal, the selection signal generating unit, and the output voltage switch sampling control unit respectively, and configured to output the output voltage switching signal to the selection signal generating unit under a control of the output voltage switch sampling control signal, such that the selection signal generating unit generates the M selection signals according to the output voltage switching signal.

15. The charging system according to claim 11, wherein the secondary control device comprises:
a secondary rectifier switch connected with the secondary winding; and
a secondary synchronous rectifier chip connected with the secondary winding and the secondary rectifier switch respectively, and configured:
to detect a voltage between two terminals of the secondary rectifier switch,
to control the secondary rectifier switch to turn on or turn off according to the voltage between two terminals of the secondary rectifier switch,
to control the secondary rectifier switch to turn on again when the secondary rectifier switch is in an off-state so as to control the secondary winding to generate the mutation voltage,
to obtain a transmission signal on the charging interface, and
to control a driving voltage of the secondary rectifier switch according to the transmission signal so as to adjust the mutation voltage.

16. The charging system according to claim 15, wherein:
the secondary rectifier switch comprises a first MOS transistor having a drain electrode connected with a first terminal of the secondary winding, a gate electrode and a source electrode; and
the secondary synchronous rectifier chip has a first power terminal connected with a second terminal of the secondary winding, a voltage sampling terminal connected with the first terminal of the secondary winding and a drain electrode of the first MOS transistor respectively, a first driving control terminal connected with the gate electrode of the first MOS transistor, a first ground terminal connected with the source electrode of the first MOS transistor, and a signal receiving terminal connected with the charging interface.

17. The charging system according to claim 16, wherein the secondary synchronous rectifier chip comprises:
a current mirror module, connected with the first power terminal and the voltage sampling terminal respectively, and configured to generate a first voltage according to a drain voltage of the first MOS transistor when the drain voltage of the first MOS transistor is less than a first predetermined voltage;
a first comparing and trigger module, connected with the current mirror module, and configured to generate a first trigger signal when the first voltage is greater than a first reference voltage and to generate a second trigger signal when the first voltage is less than a second reference voltage; and
a first driving module, connected with the first comparing and trigger module, the first power terminal and the signal receiving terminal respectively, and configured to control the first MOS transistor to turn on or turn off according to the transmission signal, a voltage at the first power terminal, the first trigger signal and the second trigger signal.
